(19) United States
(12) Patent Application Publication
(10) Pub. No.: US 2016/0201373 A1
(43) Pub. Date: Jul. 14, 2016

(54) RUNNING TRACK DEVICE FOR THE DISPLACEABLE SUPPORT OF AT LEAST ONE FIRST ROLLER CARRIAGE AND AT LEAST ONE SECOND ROLLER CARRIAGE

(71) Applicant: DORMA Deutschland GmbH, Ennepetal (DE)

(72) Inventor: Ralf HÖHER, Ennepetal (DE)

(21) Appl. No.: 14/990,490

(22) Filed: Jan. 7, 2016

(30) Foreign Application Priority Data
Jan. 14, 2015 (EP) 15151184.7

(51) Int. Cl. E05D 15/06; E05D 15/08

(52) U.S. Cl. CPC E05D 15/0652; E05D 15/0617; E05D 15/08

(57) ABSTRACT

A running track device for the displaceable support of at least one first roller carriage and at least one second roller carriage includes a first running track profile with a first roller running track for the displaceable support of the first roller carriage. The running track device further includes an attaching portion for the attachment to a wall above a door opening. A second running track profile is included having a second roller running track for the displaceable support of the second roller carriage and a mounting portion for the attachment of the second running track profile to a counter-mounting portion of the first running track profile.

### TECHNICAL FIELD

The present disclosure relates to a running track device for the displaceable support of at least one first roller carriage and at least one second roller carriage, to a sliding door installation as well as to a method for mounting a sliding door installation.

### BACKGROUND

Basically, it is known to utilize running track devices to be attached to or at a wall above a door opening. Such running track devices may include one or more roller running tracks, in which roller carriages are supported to be displaceable. Therefore, sliding doors, the door leaves thereof being attached to said roller carriages, can be moved back and forth between an opened position and a closed position. For mounting said roller carriages, they are lifted from the bottom together with the already attached door leaves and inserted into the roller running tracks.

Although the known solution allows for an easy manufacturing of the running track device; however, in particular in the event of two or more parallel offset disposed roller running tracks, mounting becomes difficult. Thus, either pushing the roller carriages in from the side or else difficult and greatly tilted lifting in, respectively pivoting onto the roller running tracks needs to be performed. Depending on the installation situation, just the one of said two solutions or even none of said two solutions is basically applicable. Therefore, it is then partly necessary to attach the sliding door when the roller carriage is inserted, namely in an upright, respectively suspended manner. This circumstance results in considerable expense, high complexity and most of all important staff deployment for realizing the mounting of such sliding doors as a telescopic configuration.

Therefore, the present disclosure aims to overcome the above-described disadvantages, at least partially. It is in particular the object of the present disclosure to improve the mounting of telescopic runners in a cost-efficient and simple way.

Further features and details of the disclosure will become apparent from the description and the drawings. In this case, features and details, described in conjunction with the inventive running track device are obviously also valid in conjunction with the inventive sliding door installation as well as with the inventive method, and respectively vice versa, such that mutual reference is made, respectively can be made with respect to the disclosure of individual aspects of the disclosure.

### SUMMARY

An inventive running track device serves for the displaceable support of at least one first roller carriage and at least one second roller carriage. For this purpose, the running track device has a first running track profile with a first roller running track for the displaceable support of the first roller carriage. The first running track profile is equipped with an attaching portion for the attachment to a wall above a door opening. Furthermore, a second running track profile with a second roller running track for the displaceable support of the roller carriage is provided. Said second running track profile is equipped with a mounting portion for the attachment of the second running track profile to a counter-mounting portion of the first running track profile.

A decisive difference according to the present disclosure compared to prior art running track devices relates to the profiles being provided in multiple parts. Thus, the first running track profile and the second running track profile are structural components, which are configured separately from each other. In this way, a mounting order, respectively a mounting ranking order is possible. Accordingly, the first running track profile can thereby be attached independently of the second running track profile at the desired position above the door opening to the wall via the attaching portion. In this position, the first roller running track is freely visible, respectively freely accessible for inserting the first roller carriage. Thus, in an inexpensive, simple way and in particular with a single mounting position, the roller carriage, respectively two or more roller carriages can be attached to the corresponding door leaf of the sliding door, and subsequently the one or the plurality of roller carriages can be lifted into the accessible first roller running track.

Only after having completed said first step of inserting is the second running track profile, which is configured separately from the first running track profile, attached to the first running track profile by placing the mounting portion against the counter-mounting portion. Thereby, said attachment includes the stationary support of the second running track profile at the first running track profile. Thus, the second running track profile and thereby also the second roller running track covers the first running track profile and thereby the first roller running track as well as the already inserted first roller carriages. However, now the second roller running track is freely accessible such that one or more roller carriages can be attached to a second door leaf. Subsequently, the combination of the second door leaf and of one or more second roller carriages can be inserted into the freely accessible second roller running track.

Finally, it is possible to provide, respectively to attach an additional sheathing to protect against soiling and against visual intrusion.

Unlike the known solutions, the two-component design of the running track device as a first and a second running track profiles allows for the mounting order explained above in detail. Thus, inserting the roller carriages and therefore the sliding doors can be realized essentially basically from the front side, namely from the access side to the door opening. In particular in narrow restricted premises this results in that basically telescopic embodiments of the sliding door installations can be installed at all. However, the option of separately installing the roller carriages from the front allows for an easier installation, also in freely accessible areas. In particular the necessity of installing in terms of sliding in from the side or a sharp angled redirection are essentially completely avoided.

In this case, the attachment between the individual running track profiles can be configured in the most various ways. Thus, both reversible and also irreversible attachments are possible between the mounting portion and the counter-mounting portion. However, reversible solutions, for example in the shape of screws or threaded pins are preferred so that dismounting can be performed for maintenance work, respectively repair work.

Furthermore it is advantageous, if, in an inventive running track device, the first roller running track and the second roller running track are disposed parallel to each other and are disposed offset to each other perpendicularly to the direction of movement of the roller carriages. Preferably, in telescopic embodiments of sliding door installations, a parallel movement of a first door leaf and of a second door leaf to each other is desired. Accordingly, the parallel configuration and orientation of the two roller running tracks determines, respectively replicates said parallel option of movement of the two door leaves. In this case, the two roller running tracks are configured at maximum with a same length. In particular a simplified manufacturing and a simplified installation are possible on account of the same length. Perpendicularly to the direction of movement offset means that, away from the wall above the door break-through, a differently sized distance is provided for the two roller running tracks. In other words, a movement gap is thus created between the two door leaves, which gap, based on the distance perpendicularly to the direction of movement, is caused by the two roller running tracks. This circumstance allows for overlapping telescoping and thereby for the little space requirement in the opened position of the sliding door installations.

It is likewise advantageous, if, in an inventive running track device, the first roller running track of the first running track profile is configured to be shorter, in particular has about a third of the length of the second roller running track of the second running track profile. In particular two or more door leaves are provided in a telescopic configuration of a sliding door installation. They move in a completely overlapping position into the opened position, and in an almost not overlapping, respectively little overlapping position they move into the closing position. The simultaneous movement and the different lengths of movement result in that the two door leaves are moving at different speeds. Therefore, they are also referred to as slow runners and fast runners. In the event the two door leaves are essentially configured to have the same length, preferably this results in that at simultaneous synchronous movement, the fast runner covers double the distance of the slow runner. The differences in the synchronous speed of movement and the differences resulting therefrom in the respective distance of movement are preferably replicated by the geometrical orientation of the two roller running tracks. On the one hand, this circumstance reduces the use of material and the thereby incurred costs as well as the corresponding weight of the overall running track device.

Furthermore, it is advantageous, if, in an inventive running track device, the mounting portion and/or the counter-mounting portion include/s a variation device for varying the distance perpendicularly to the direction of movement of the roller carriages, of the height difference along the direction of gravity and/or of the angle offset between the first roller running track and the second roller running track. Thereby, one, two, three or also any number of variation options are given by the variation device. Obviously, in this case, individual variation partial devices may be intended for providing respectively one variation function. A readjustment perpendicularly to the direction of movement allows for an adjustment to different door thickness of the door leaves of the sliding door. The height difference along the direction of gravity allows for providing a height offset, which correlates with different door lengths. An angle offset allows for providing an adjusting option for difficult insertion positions, in particular in the area of curved roller running tracks and curved door leaves. Altogether, an appropriate adjustment for a clean movement pattern can be performed on the mounting site in this way for example with oblong holes or for example with different parts or thread solutions.

It may also be an advantage, if, in an inventive running track device, the mounting portion includes a mounting surface for the full contact against a counter-mounting surface of the counter-mounting portion. Preferably in this case, the mounting surface and the counter-mounting surface include correlating surfaces, which are in particular both configured as planes. However, also more complicated surfaces, in particular for configuring an at least sectionwise positive connection at this location, are conceivable within the framework of the present disclosure. The configuration of surfaces for the mounting portion and the counter-mounting portion improves the orientation of said two portions, respectively of the two running track profiles to each other. In particular, the desired parallelism of the two roller running tracks during mounting is improved in this way considerably. In this embodiment, the required mounting forces and bearing forces can be supported in full contact such that the punctual mechanical load of said individual structural components can be considerably reduced.

Another advantage can be achieved, if, in an inventive running track device, the mounting surface and the counter-mounting surface are aligned along or essentially along the direction of gravity. This means that the two surfaces are provided essentially vertically, in order to reduce or even completely avoid tilting moments during installation and during operation. In particular according to this circumstance, it has been referred to, respectively a correlation has been established to the parallel direction of movement, and to an easier adjusting offset in said direction of movement of the two door leaves.

It may be another advantage, if, in an inventive running track device, the second roller running track of the second running track profile is disposed offset above the first roller running track of the first running track profile, preferably with an offset distance ranging between 0.2 and 0.8 of the diameter of a rotatable bearing means of the second roller carriage. Usually, the rotatable bearing means are provided in the shape of radial rollers, which may for example run on ball bearings. An upward offset of the second roller running track allows for provided a larger opening clearance for placing a corresponding roller carriage onto the first roller running track. Moreover preferably, the described offset allows for a possible identically configured length of the two door leaves to each other. This is in particular possible in a way that the two door leaves are configured identical, because, although with the small height offset of the two roller running tracks, on the one hand an easier inserting mountability is guaranteed, but on the other hand, the complexity is lessened by reducing the overall number of structural components by means of same door leaves.

A further advantage may be provided, if, in an inventive running track device for the attachment of the mounting portion to the counter-mounting portion, a mounting means with a mounting axis is employed, which is oriented parallel or essentially parallel to the axis of rotation of a rotatable bearing means. Mounting is facilitated in this way again, because a frontal accessibility is made possible. Thus, for example by means of a mounting assisting means in the shape of a screwdriver, a corresponding screw head as an interface can be worked on. Avoiding oblique torques on said mounting means by means of said orientation will entrain a reduction of the mechanical load on the mounting means. In this case, in particular the mounting axis is defined as the axis of the main extension and/or as the axis of the mounting movement, both axially and rotary for the mounting means.

Furthermore, it may be advantageous, if, in an inventive running track device, the first running track profile and/or the second running track profile include a fixing portion for attaching a faceplate device for covering the second roller running track. In this case, it is question of a third additional structural component, which is attached at the end, after having inserted the at least one second roller carriage. In this way, the view into as well as the mechanical interference by dirt or dust can be even further reduced. For this purpose, such a faceplate device may include a corresponding counter-fixing portion for the appropriate attaching functionality. In this case, the extension of the faceplate portion in relation to the direction of gravity is preferably larger than the corresponding extension of the roller carriage, with the intention to provide here an essentially completely covering by a faceplate. Preferably, the faceplate portion extends as far in the direction of the direction of movement of the roller carriage as the first and/or the second running track profiles.

It is likewise an advantage, if, in an inventive running track device, the second running track profile includes a running track faceplate portion for an at least partial covering of the first roller running track. As the appropriate configuration and lack of the second running track profile allow for a free accessibility to the first roller running track, the running track faceplate portion now serves the purpose of preventing said free accessibility and to guarantee a corresponding mechanical protection. In particular in this way, a separation of the spaces of the two roller running tracks is provided such that soiling by means of wear and tear, in particular by means of wear of the fast runner as cross-contamination is prevented, respectively reduced. Preferably, said running track faceplate portion includes a full covering effect, which in particular extends over the entire length of the second running track profile.

It is likewise an advantage, if, in an inventive running track device, the first running track profile and/or the second running track profile are formed as an extruded profile. Said profiles may be configured for example in an L-shape for being provided nested into each other for an easier and moreover space-saving storage, respectively for correspondingly improved and inexpensive shipping. An extruded profile with a correspondingly consistent cross-section also considerably reduces the manufacturing cost as well as the manufacturing expense.

Likewise the present disclosure provides a sliding door installation including an inventive running track device, wherein at least one first roller carriage is supported to be displaceable on the first roller running track and further at least one second roller carriage is supported to be displaceable on a second roller running track. The inventive sliding door installation thus offers the same advantages as those explained in detail with regard to an inventive running track device. Preferably, appropriate door leaves of the sliding door are attached to the individual roller carriages. Thus, per door leaf also a number of two or more roller carriages may be employed.

Likewise the present disclosure provides a method for mounting a sliding door installation according to the present disclosure, including the following steps:
attaching the first running track profile to a wall above a door opening by means of the attaching portion,
inserting the at least one first roller carriage onto the first roller running track,
attaching the second running track profile by means of the mounting portion to the counter-mounting portion of the first running track profile,
inserting the at least one second roller carriage onto the second roller running track,

By employing an inventive running track profile, the inventive method offers the same advantages as those explained in detail in relation to the inventive running track profile. In this case, the attachment of door leaves to the roller carriages may be performed in advance, as well as to the already inserted roller carriages.

### BRIEF DESCRIPTION OF THE DRAWINGS

Further advantages, features and details of the disclosure will result from the following description, in which exemplary embodiments of the disclosure are described in detail, reference being made to the drawings. It is diagrammatically shown in:

FIG. 1 the first step of an inventive method,

FIG. 2 a further step of the method,

FIG. 3 a further step of the method,

FIG. 4 a further step of the method,

FIG. 5 a further step of the method, and

FIG. 6 completing the method and thereby an inventive running track device.

### DETAILED DESCRIPTION OF THE DRAWINGS

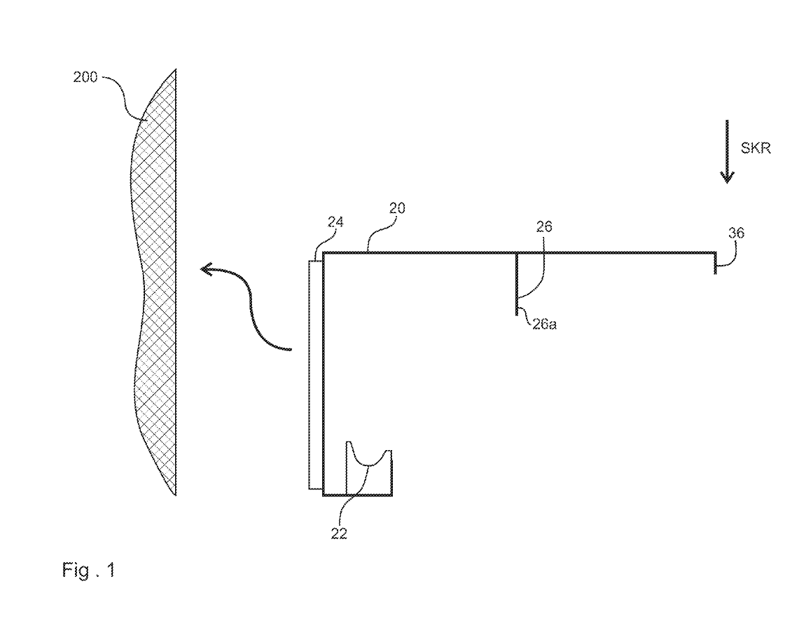

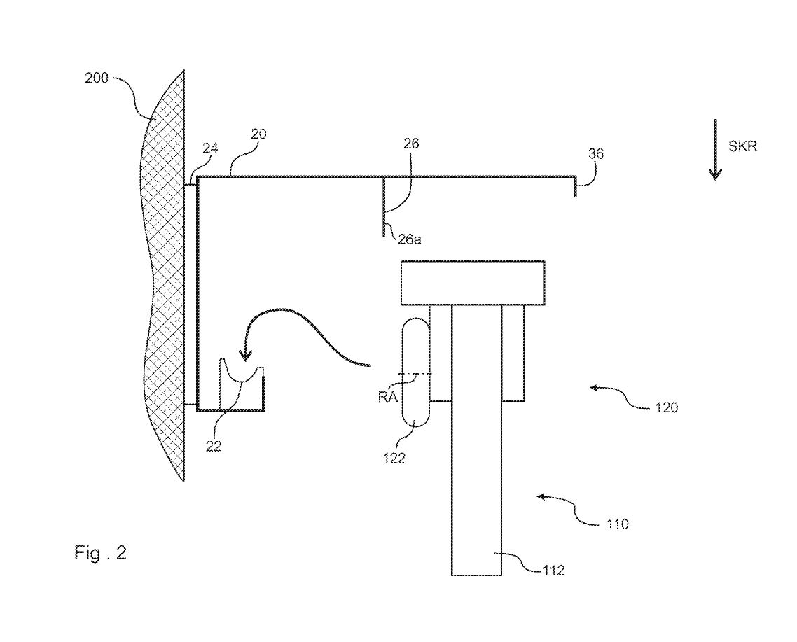

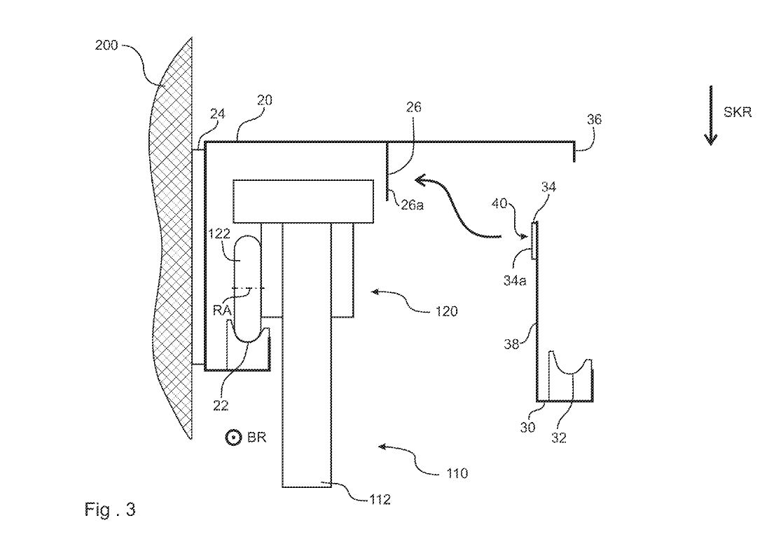

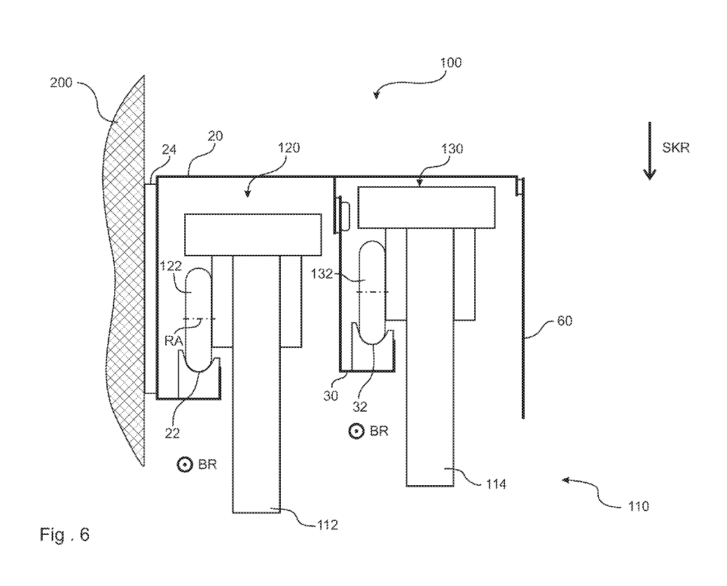

Based on FIGS. 1 to 6, performing an inventive method is explained, such that as a final result an inventive sliding door installation 100 with an inventive running track device 10 is provided as a pre-mounded version. Based on the situation according to FIG. 1, now a first running track profile 20 is attached to a corresponding wall 200 above a door opening. For this purpose, the attaching portion 24 is provided in a full contact such that for example a screw connection can be realized at the wall 200. As soon as this is realized, according to FIG. 2 the second running track profile 20 is located in the attached situation at the wall 200, such that now the first roller carriage 120 together with the first door leaf 112 of the sliding door 110 can be inserted into the associated first roller running track 22. In this case, inserting is realized by means of corresponding rotatable bearing means 122, which are configured to be rotatable about a corresponding axis of rotation RA. As can be seen in FIG. 2, correspondingly, free accessibility to the first roller running track 22 is given.

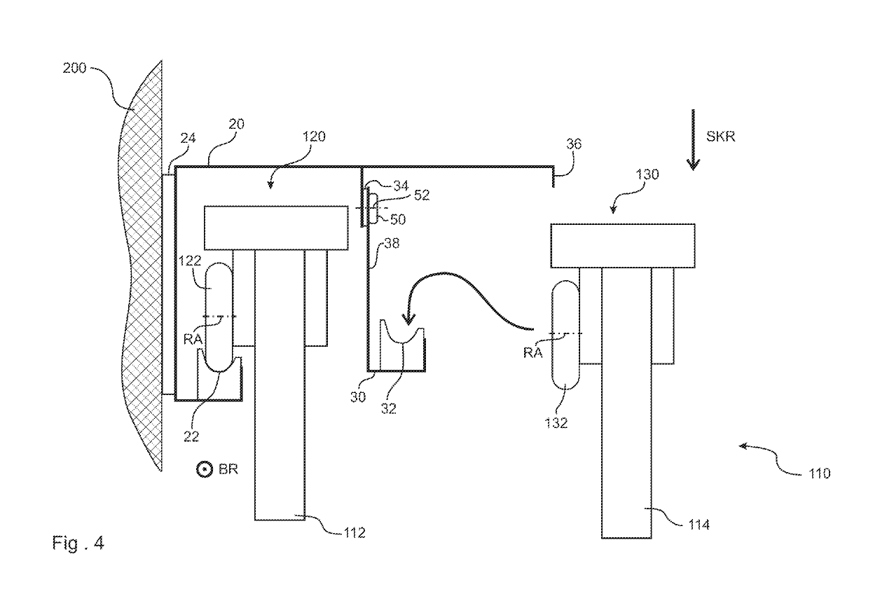

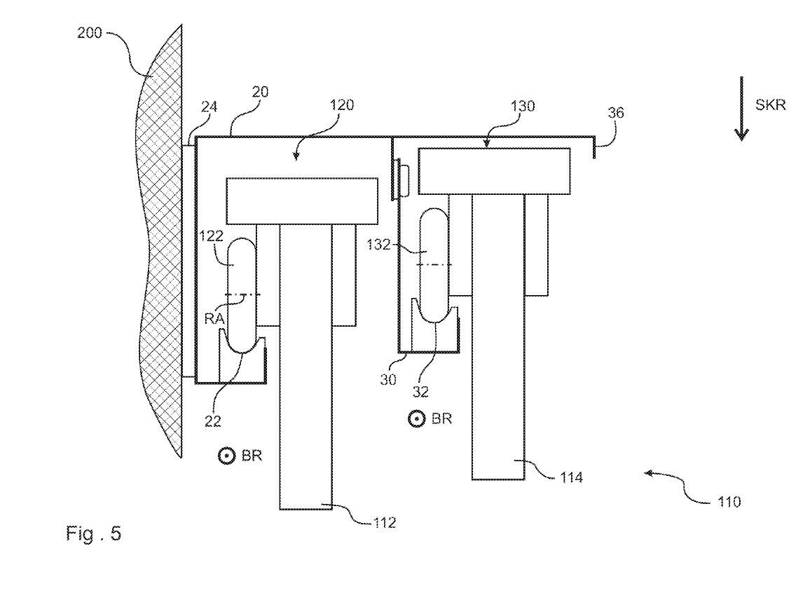

After inserting the first roller carriage 120, further mounting of the running track device 10 can be performed. Thus, now a second running track profile 30 can be attached via a mounting portion 34 and the mounting surface 34a thereof to a counter-mounting portion 26 and the counter-mounting surface 26a. The final situation is shown in FIG. 4, in which a corresponding mounting means 50 has been disposed with its mounting axis 52 aligned parallel to the axis of rotation RA of the two bearing means 122 and 132. In a similar way, now the second roller carriage 130 together with the second door leaf 114 of the sliding door 110 can be inserted into the associated second roller running track 32. Once this is completed, a first embodiment of the sliding door installation 100 is provided, as shown in FIG. 5. Finally, it is possible that now a fixing portion 36 allows for additionally attaching a faceplate device 60. Said faceplate device 60 prevents visual intrusion and additional soiling of the second roller running track 30.

As can be likewise seen in the Figures, the direction of movement BR of the individual roller carriages 120 and 130 is configured to be vertical to the plane of the drawing. Accordingly, the two roller running tracks 22 and 32 are disposed perpendicularly offset to said direction of movement BR and vertical offset in the direction of height.

The above explanation of the embodiments describes the present disclosure exclusively based on examples. Obviously, individual features of the embodiments, as long as technically reasonable, can be combined independently of each other without leaving the scope of the present disclosure.

1. A running track device for the displaceable support of at least one first roller carriage and at least one second roller carriage (130), including a first running track profile with a first roller running track for the displaceable support of the first roller carriage and with an attaching portion for the attachment to a wall above a door opening, and including a second running track profile with a second roller running track for the displaceable support of the second roller carriage and with a mounting portion for the attachment of the second running track profile to a counter-mounting portion of the first running track profile.

2. The running track device according to claim 1, wherein the first roller running track is disposed parallel to the second roller running track and the first and second roller running tracks are disposed perpendicularly to the direction of movement of the roller carriages.

3. The running track device according to claim 1, wherein the first roller running track is configured to be approximately one third of the length less than the second roller running track.

4. The running track device according to claim 1, wherein the mounting portion and/or the counter-mounting portion includes a variation device for varying the distance perpendicularly to the direction of movement of the roller carriages, of the height difference along the direction of gravity and/or of the angle offset between the first roller running track and the second roller running track.

5. The running track device according to claim 1, wherein the mounting portion includes a mounting surface for the full contact at a counter-mounting surface of the counter-mounting portion.

6. The running track device according to claim 5, wherein the mounting surface and the counter-mounting surface are aligned along or essentially along the direction of gravity.

7. The running track device according to claim 1, wherein the second roller running track is disposed offset above the first roller running track having an offset distance ranging between 0.2 and 0.8 of the diameter of a rotatable bearing means of the second roller carriage.

8. The running track device according to claim 1, wherein a mounting means with a mounting axis, which is aligned parallel or essentially parallel to an axis of rotation of a rotatable bearing means, is employed for the attachment of the mounting portion to the counter-mounting portion.

9. The running track device according to claim 1, wherein the first running track profile and/or the second running track profile include/s a fixing portion for the attachment of a faceplate device for covering a second roller running track.

10. The running track device according to claim 1, wherein the second running track profile includes a running track faceplate portion for an at least partial covering of the first roller running track.

11. The running track device according to claim 1, wherein the first running track profile and/or the second running track profile are/is configured as an extruded profile.

12. A sliding door installation including a running track device having the features of claim 1, wherein at least one first roller carriage is supported to be displaceable on the first roller running track and at least one second roller carriage is supported to be displaceable on the second roller running track.

13. A method for mounting a sliding door installation having the features of claim 12, the method including the following steps:
attaching the first running track profile to a wall above a door opening by means of an attaching portion,
inserting the at least one first roller carriage onto the first roller running track,
attaching the second running track profile by means of the mounting portion to the counter-mounting portion of the first running track profile, and
inserting the at least one second roller carriage onto the second roller running track.
